(19) United States
(12) Patent Application Publication
(10) Pub. No.: US 2018/0165954 A1
(43) Pub. Date: Jun. 14, 2018

(54) DYNAMIC TRAFFIC LANE ASSIGNMENT

(71) Applicant: Faraday&Future Inc., Gardena, CA (US)

(72) Inventor: Xiufeng Song, San Jose, CA (US)

(21) Appl. No.: 15/659,870

(22) Filed: Jul. 26, 2017

Related U.S. Application Data
(60) Provisional application No. 62/366,868, filed on Jul. 26, 2016.

(51) Int. Cl. G08G 1/056; G08G 1/01; G08G 1/09

(52) U.S. Cl. CPC G08G 1/056; G08G 1/0145; G08G 1/012; G08G 1/0112; G08G 1/09

(57) ABSTRACT

Methods, systems, and apparatuses to a plurality of markers embedded on a road, the plurality of markers arranged in a line and configured to define a border of at least one lane in a plurality of lanes on the road; and the plurality of markers further configured to dynamically assign a driving designation to the at least one lane on the road. Methods, systems, and apparatuses to obtain virtual representation information for a plurality of virtual markers arranged in a line to define a virtual border of at least one virtual lane in a plurality of virtual lanes on a road, and to dynamically assign a driving designation to the at least one virtual lane on the road.

### CROSS-REFERENCE TO RELATED APPLICATIONS

This application claims the benefit of U.S. Provisional Application No. 62/366,868, filed Jul. 26, 2016, the entirety of which is hereby incorporated by reference.

### BACKGROUND

Aspects of the disclosure relate to flow of vehicular traffic on roads. Typically, lanes of a road are permanently assigned for a fixed number of lanes in either direction. Vehicular traffic flow, however, can vary greatly in intensity between lanes of different directions. For example, during rush hour periods the northbound lanes can experience heavy traffic flow while the southbound lanes experience light traffic flow. This can result in an overall inefficient usage of traffic lanes on a road. Exemplary embodiments of the disclosure address these problems, both individually and collectively.

### SUMMARY

Certain embodiments are described for dynamic traffic lane assignment on roads. An exemplary embodiment includes an apparatus having a plurality of markers embedded on a road, the plurality of markers arranged in a line and configured to define a border of at least one lane in a plurality of lanes on the road, and the plurality of markers are further configured to dynamically assign a driving designation to the at least one lane on the road.

Another exemplary embodiment includes an apparatus having a processor configured to obtain virtual representation information for a plurality of virtual markers arranged in a line to define a virtual border of at least one virtual lane in a plurality of virtual lanes on a road, the processor further configured to dynamically assign a driving designation to the at least one virtual lane on the road, and a data storage unit configured to communicate with the processor and to store the virtual representation information.

Another exemplary embodiment includes an apparatus having a first means for dynamically assigning a driving designation to at least one lane in a plurality of lanes on a road, and means for altering a pattern represented by a plurality of markers embedded on the road based on the dynamically assigning, the plurality of markers arranged in a line to define a border of the at least one lane on the road.

Another exemplary embodiment includes an apparatus having a first means for obtaining a virtual representation information for a plurality of virtual markers arranged in a line to define a virtual border of at least one virtual lane in a plurality of virtual lanes on a road, and means for dynamically assigning a driving designation to the at least one virtual lane on the road.

Another exemplary embodiment includes a method comprising dynamically assigning a driving designation to at least one lane in a plurality of lanes on a road; and altering a pattern represented by a plurality of markers embedded on the road based on the dynamically assigning, the plurality of markers arranged in a line to define a border of the at least one lane on the road.

Another exemplary embodiment includes a method comprising obtaining a virtual representation information for a plurality of virtual markers arranged in a line to define a virtual border of at least one virtual lane in a plurality of virtual lanes on a road; and dynamically assigning a driving designation to the at least one virtual lane on the road.

### BRIEF DESCRIPTION OF THE DRAWINGS

Aspects of the disclosure are illustrated by way of example. In the accompanying figures, like reference numbers indicate similar elements.

FIG. 1 illustrates an example environment in which various aspects of the disclosure can be implemented.

FIG. 2 and FIG. 3 further illustrate the example environment of FIG. 1, in which various aspects of the disclosure can be implemented.

FIG. 4 includes a block diagram further illustrating various components for implementing aspects of the disclosure.

FIG. 5 illustrates another aspect of the disclosure.

FIG. 6 illustrates an exemplary display for implementing various aspects of the disclosure.

FIG. 7A and FIG. 7B, in conjunction with FIGS. 1-6, illustrate exemplary operation flows of various aspects of the disclosure.

### DETAILED DESCRIPTION

Examples are described herein in the context of dynamic traffic lane assignment on roads. Embodiments provided in the following description are illustrative only and not intended to limit the scope of the present disclosure. Reference will now be made in detail to implementations of examples as illustrated in the accompanying drawings. The same reference indicators will be used throughout the drawings and the following description to refer to the same or like items.

In the interest of clarity, not all of the routine features of the examples described herein are shown and described. It will, of course, be appreciated that in any such actual implementation, numerous implementation-specific details may nevertheless exist in order to achieve goals such as compliance with application- and business-related constraints, and that these specific goals can vary from one implementation to another.

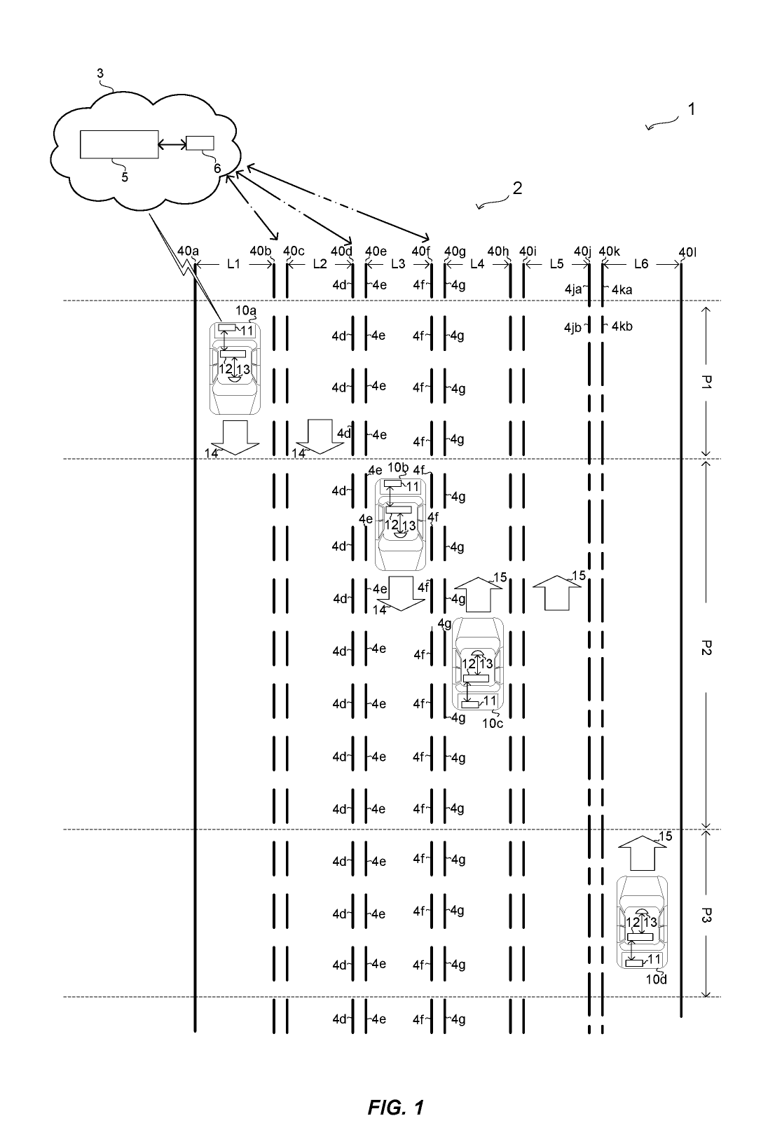

FIG. 1 illustrates an example environment 1 in which the various aspects of the disclosure can be implemented in the exemplary context of a multi-lane bi-directional road 2 having six lanes L1-L6. In an exemplary embodiment, a plurality of markers, such as 4f, are embedded on road 2, such as by being fixed firmly into the surrounding paving materials (e.g. asphalt, concrete etc.) used on road 2. In an exemplary embodiment, only portion(s) of a marker is embedded, while other portion(s) of the marker, such as the top portion(s), may protrude to above its surrounding paving materials in a pronounced manner for improved visibility. As shown in FIG. 1, the markers 4f are arranged in a line 40f and are configured to define at least one border of a lane, such as L3.

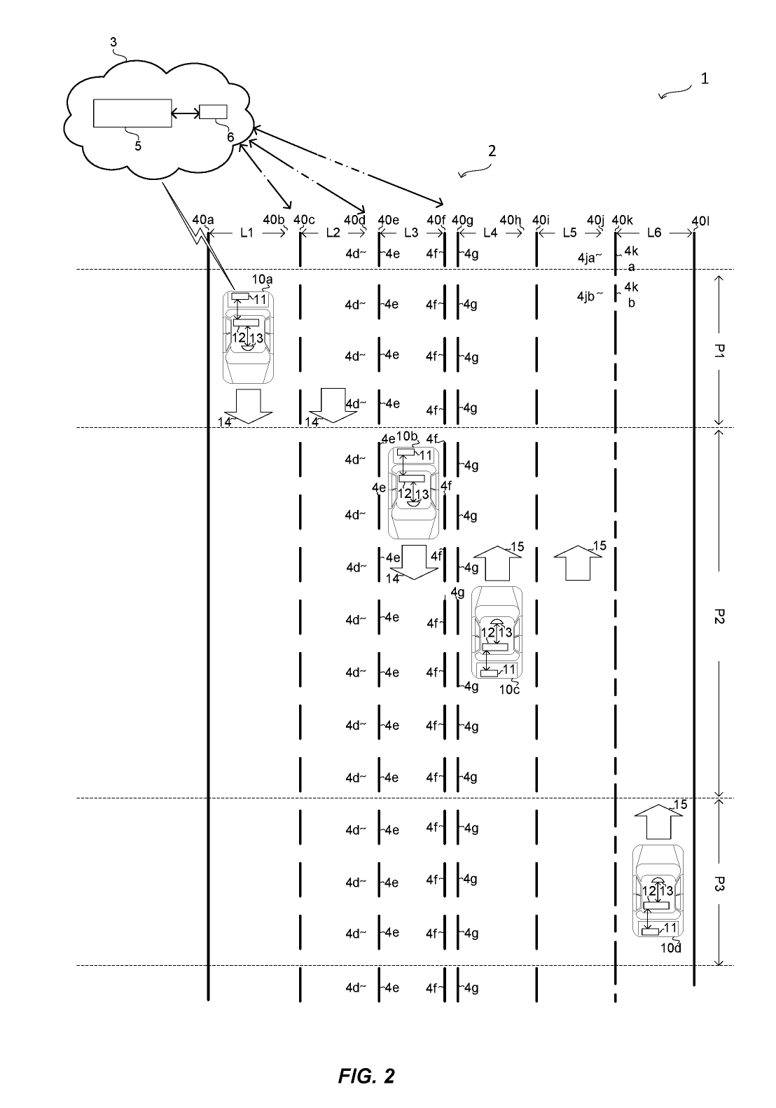

As shown in FIG. 1, the markers arranged in each of the lines 40a-40l are configured to define border(s) of their respective lanes L1-L6, as further described below and in greater detail in conjunction with FIGS. 2-6. For simplicity of illustration, the markers are generally shown in FIG. 1 as having equal-length and separated by equal distances (e.g. 4f), although it is contemplated that the markers can be of varying length (e.g. markers 4ja, and 4jb, or 4ka and 4kb) as well as separated by varying distances such as with reduced distances so as to form a solid line (e.g. lines 40a and 40l), such as for representing the boundaries of road 2.

As shown in FIG. 1, exemplary road 2 is bidirectional, having three lanes L1-L3 with traffic flow, such as by vehicles 10a, and 10b, in a direction shown by arrow(s) 14, and three lanes L4-L6 with traffic flow, such as by vehicles 10c and 10d, in an opposite direction shown by arrow(s) 15.

As further described below and in greater detail in conjunction with FIGS. 2-6, the markers are configured to dynamically assign a driving designation to one or more of lanes L1-L6 on road 2. By way of non-limiting examples, the driving designation for a lane may include one or more of (a) a direction of traffic in a lane, such as direction of arrow(s) 14 or arrow(s) 15, (b) a vehicle occupancy criteria, such as carpool or high occupancy vehicle (HOV), in a lane, (c) a vehicle speed limit in a lane, or (d) an operational status, such as closed, construction zone, etc, for a lane. In an exemplary embodiment, a remote server 5, such as one residing in a cloud service 3, dynamically assigns a driving designation to one or more of lanes L1-L6 on road 2. The dynamic assignment can be performed, for example, via communication device(s) 6, which is in direct or in-direct communication with the markers, such as markers 4b, 4c, 4d, 4e, 4f, 4g, 4h, 4i, 4j, and 4k.

The operations of the dynamic traffic lane assignment for road 2 will now be described in greater detail in conjunction with FIGS. 2-4.

FIG. 2 illustrates an exemplary traffic state in road 2 in which traffic flow volume in directions for each of arrow(s) 14 and 15 are substantially equal. In this exemplary state, lanes L1-L3 are assigned the driving designation for traffic in direction of arrow(s) 14 and lanes L4-L6 are assigned the driving designation for traffic in direction of arrow(s) 15. The markers are assigned a pattern in which the lanes of each direction appear separated by a single set of markers. For example, the markers 4d corresponding to line 40d are turned to OFF, and so appear as less visible (illustrated as blanc in FIG. 2), while the markers 4e corresponding to line 40e are turned to ON and thus appear as more visible. As such, the border between lanes L2 and L3 is practically defined by a single set of markers 4e arranged in a line 40e. The same pattern alteration is also applied to define boundaries between other lanes of the same direction, such as in the case of the markers of lines 40b and 40c between lanes L1 and L2, the markers of lines 40h and 40i between lanes L4 and L5, and the markers of lines 40j and 40k between lanes L5 and L6.

In the exemplary embodiment shown in FIG. 2, the markers 4f and 4g of lines 40f and 40g act as the double-line divider between lanes of opposite traffic directions, and are therefore both turned to ON, so as to appear as a double-line defining a border separating the opposite flows of traffic between lanes L3 and L4.

It should be noted that other methods of visually differentiating between the markers for the purposes of dynamically assigning the driving designation, such as defining a border separating the opposite flows of traffic, can also be used. For example, the use of differentiating coloring lights, etc., is contemplated to be within the scope of the present disclosure.

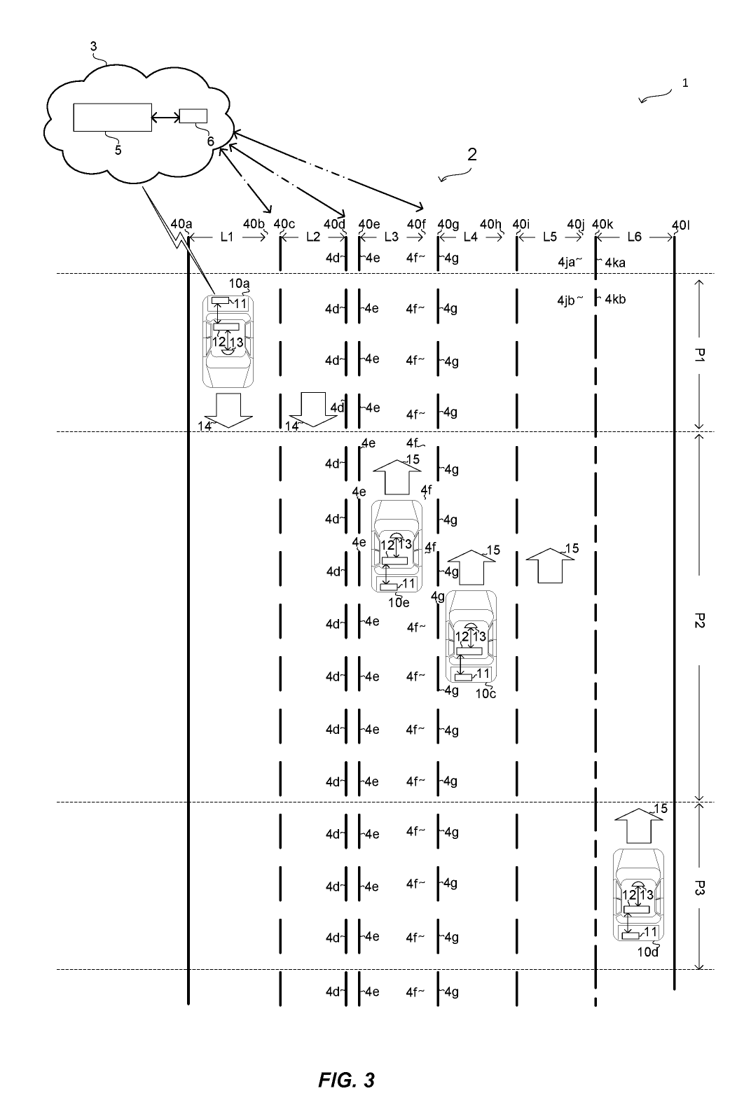

FIG. 3 illustrates an exemplary traffic state in road 2 in which traffic flow volume in the directions for arrow(s) 14 and 15 is substantially different, with more vehicles travelling in the direction of arrow 15 than in the direction of arrow 14. For simplicity of illustration, three vehicles 10c, 10d and 10e are shown travelling in the direction of arrow 15, and one vehicle 10a travelling in the direction of arrow 14.

In this exemplary state of road 2, two lanes (L1 and L2) are assigned the driving designation for traffic in the direction of arrow(s) 14, while four lanes (L3-L6) are now assigned the driving designation for traffic in the direction of arrow(s) 15. The pattern of the markers previously shown in FIG. 2 is now dynamically altered to represent the change in traffic flow assignment for lane L3 from the direction of arrow(s) 14 to the direction of arrow(s) 15. For example, the markers 4f corresponding to line 40f are turned to OFF (illustrated as blank in FIG. 3), while the markers 4d corresponding to line 40d are turned to ON. The markers 4d and 4e now act as the double-lines (40d and 40e) defining a new border separating the opposite flows of traffic between lanes L2 and L3.

It should be noted that more than one lane can be dynamically assigned to a driving designation. For example, all of lanes L1-L6 can be assigned to a same direction of traffic flow, if needed.

In an exemplary embodiment, the dynamic assignment of the driving designation for traffic can be performed for a portion(s) of lane(s), such as for any combinations of portions P1, P2 and/or P3 for any combination of lanes L1-L6.

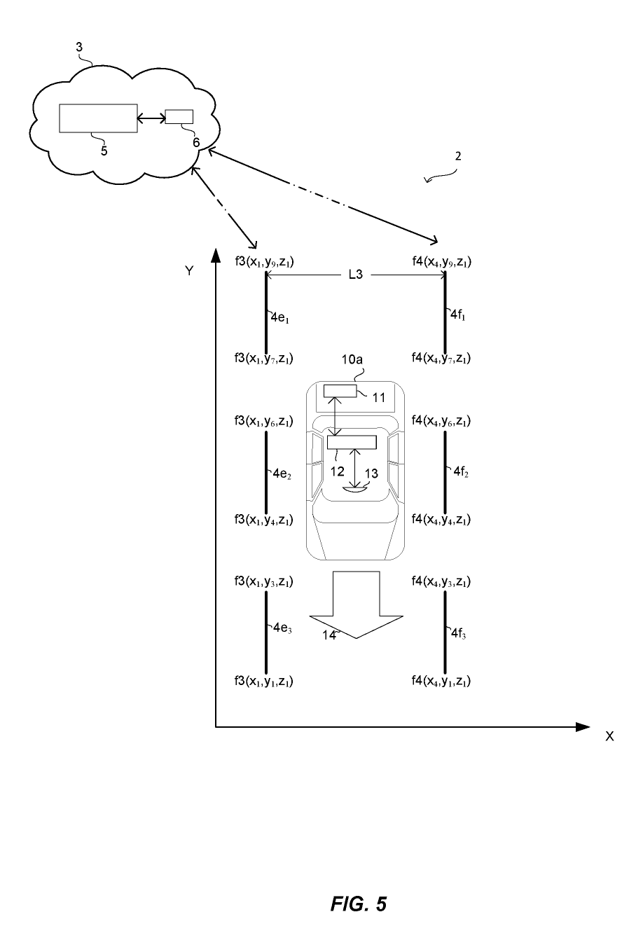

In an exemplary embodiment, the dynamic assignment of the driving designation for traffic can determined based on mobile crowd sourcing, such as via traffic information gathered from sensor(s) 13 housed in vehicle(s) travelling on road 2 in real-time (such as vehicles 10a-10f) as described later in conjunction with FIG. 5, based on a history of traffic conditions of road 2, and/or based on other factors.

In an exemplary embodiment remote server 5 is further configured to use the traffic information from real-time, road history, and/or other sources to dynamically and predictively assign a driving designation to any portion of any lane, such as portion P2 of lane L3, prior to a projected arrival of a vehicle, such as vehicle 10a, at that portion.

Exemplary embodiments of the disclosure therefore enable the dynamic assignment of the driving designation for a lane or a portion of a lane, so that for example at a time T₁, such as night time, a lane or portion of a lane may have one driving designation, such as for a flow of traffic in one direction, while at a time T₂, such as during rush hour, a lane or portion of a lane may have another driving designation, such as for a flow of traffic in opposite direction of that at time T₁.

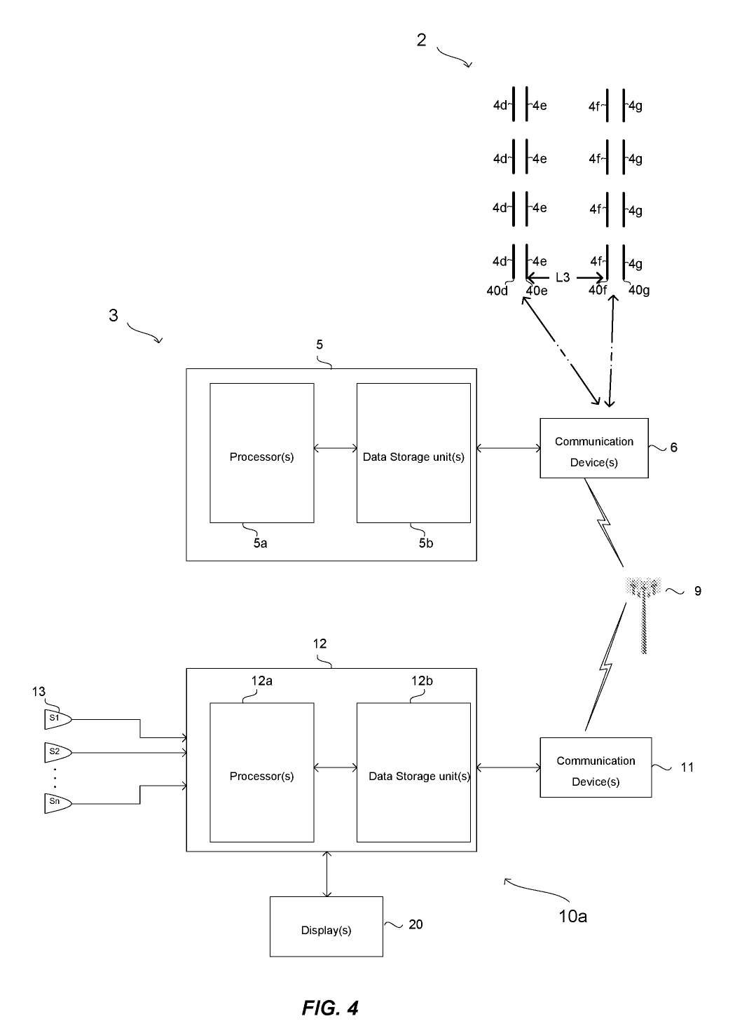

FIG. 4 includes a block diagram which in conjunction with FIG. 1-3 further illustrates the operations and various components for implementing aspects of the disclosure. As shown in FIG. 4, a remote server 5, such as one residing in a data cloud 3, includes processor(s) 5a and data storage unit(s) 5b. Processor(s) 5a is configured to dynamically assign traffic designations to lanes L1-L6 on road 2, such as based on information provided by data storage unit(s) 5b. Remote server 5 is further configured to communicate, via communication device(s) 6, such as by wired or wireless media, with the markers on road 2, to dynamically assign traffic designation to lanes L1-L6 on road 2, such as to lane L3 and markers 4d-4g, as shown in FIG. 4.

In an exemplary embodiment, remote server 5 is also configured to communicate, such as via communication device(s) 6 and cellular communication base-station 9, with communication device(s) 11 on vehicle(s) 10a-10d on road 2, for obtaining traffic condition information on road 2. As shown in FIG. 4, an exemplary vehicle 10a includes a traffic information system 12 which includes processor(s) 12a and data storage unit(s) 12b. The traffic information system 12, housed within vehicle 10a, receives traffic data from sensors(s) 13. Each of sensor(s) 13 is configured to perform one or more types of scene observation such as via a camera, thermal sensing such as infrared, Light Detection And Ranging (LIDAR) or Radio Detection and Ranging (RADAR), amongst other forms of sensing. It is also contemplated that sensor(s) 13 could be distributed throughout vehicle 10a in different configurations or arrangements that provide improved data gathering, operating either as stand-alone sensors or as a collection of sensors working together. In an exemplary embodiment, display unit(s) 20, such as interactive display unit(s), are in communication with vehicle traffic information system 12 and are configured to provide and/or receive visual and/or audio data to and from the driver of vehicle 10a, as described below and in greater detail in conjunction with FIG. 5.

FIG. 5, in conjunction with FIGS. 1-4, illustrates another aspect of the disclosure in which the markers on road 2 are virtually represented according to various embodiments. As shown in FIG. 5, in one embodiment, each of the markers, such as markers 4e₁, 4e₂, 4e₃, or 4f₁, 4f₂, 4f₃, may be represented by a mathematic function. For example, marker 4e₁ may be represented by a function f3(x, y, z) which may have a value of ON (e.g., “1”) in the range from f3(x₁, y₉, z₁) to f₃(x₁, y₇, z₁). In this example, the geographical coordinates x, y, and z are based on a Cartesian coordinate system. Other markers 4e₂, 4e₃, or 4f₁, 4f₂, 4f₃ may be similarly represented, as shown in FIG. 5. For simplicity, the Z-axis used for road elevation is not shown in the “bird's eye” view of FIG. 5. The virtual markers define a border of a virtual lane, such as virtual lane L3 in FIG. 5.

According to certain embodiments of the disclosure, a function such as f3(x,y,z) may be defined with constraints to smooth out any transitions in lane assignment. For example, one or more of the following constraints may be applied: (a) f3(x,y,z) is to be a continuous function; (b) f3′(x,y,z), the first derivative f3(x,y,z), is to be a continuous function; (c) f3″(x,y,z), the second derivative of f3(x,y,z), is to be a continuous function; and/or (d) other constraints.

Other features of road 2, such as boundaries 40a and 40l, lane portioning such as P1, P2 and P3, etc. (shown in FIGS. 1-3), as well as traffic signs and signals (not shown), can also be similarly represented in virtual forms, and are within the scope of the present disclosure. It should also be noted that any location positioning or location marking coordinate system, such as Global Positioning Satellite system, digital maps, etc., can be used in accordance with the above, and is contemplated to be within the scope of the present disclosure.

In this exemplary embodiment, processors(s) 5a of remote server 5 is configured to obtain virtual representation information for virtual markers, such as 4e₁, 4e₂, 4e₃, or 4f₁, 4f₂, 4f₃ and to dynamically assign a driving designation to at least one virtual lane on road 2, such as lane L3 as shown in FIG. 5.

In an exemplary embodiment, the processor(s) 12a housed within a vehicle, such as vehicle 10a in FIG. 5, on road 2, is configured to obtain virtual representation information for virtual markers, such as from remote server 5, and to autonomously navigate vehicle 10a on road 2 based on the virtual representation information.

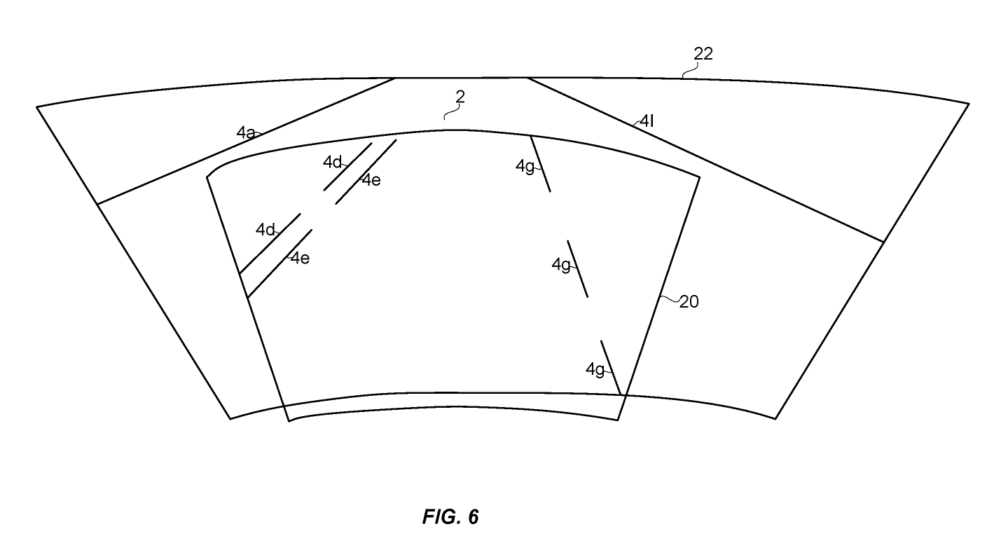

In another exemplary embodiment, the processor(s) 12a housed within a vehicle, such as vehicle 10e in FIG. 3, on road 2, is configured to obtain virtual representation information for virtual markers, such as from remote server 5, and to display virtual markers to a driver of vehicle 10a, as shown in FIG. 6.

FIG. 6 shows an exemplary embodiment in which the virtual representation information are graphically displayed on a display unit 20, such as a head-up display (HUD), configured to virtually superimpose virtual markers on the driver's view of road 2. Here, display unit may be part of a vehicle 10e, travelling on road 2, for example. As shown in FIG. 6, virtual markers 4e and 4d, which together represent the double-line divider between lanes of opposite traffic directions, as well as single lane markers 4g, are virtually superimposed by display unit 20 on road 2. In an exemplary embodiment, display unit 20 occupies a portion or all of windshield 22. In another exemplary embodiment (not shown), display unit 20 is integrally formed with windshield 22, and occupies a portion or all of windshield 22.

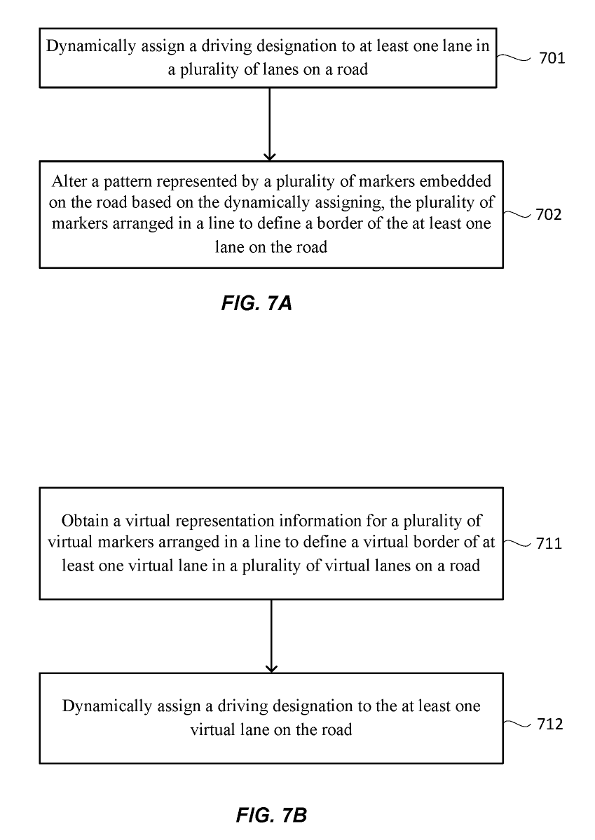

FIG. 7A, in conjunction with the descriptions provided above for FIGS. 1-4, illustrates an exemplary operation flow of various aspects of the disclosure. Starting in block 701, a driving designation is dynamically assigned to at least one lane in a plurality of lanes on a road 2.

Next, in block 702, a traffic flow pattern represented by markers embedded on road 2 is altered based on the dynamic assignment the driving designation of block 701. In an exemplary embodiment, the markers are arranged in a line to define a border of the at least one lane on road 2, as previously shown and discussed in conjunction with FIGS. 1-4.

FIG. 7B, in conjunction with the descriptions provided above for FIGS. 1-6, illustrates an exemplary operation flow of various aspects of the disclosure. Starting in block 711, virtual representation information is obtained for virtual markers arranged in a line to define a virtual border of at least one virtual lane on road 2.

Next, in block 712, a driving designation is dynamically assigned to the at least one virtual lane on road 2, as previously shown and discussed in conjunction with FIGS. 1-6.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims recite various steps in a sample order. Unless otherwise specified, the order in which the steps are recited is not meant to require a particular order in which the steps must be executed.

The previous description is provided to enable any person skilled in the art to practice the various aspects described herein. Various modifications to these aspects will be readily apparent to those skilled in the art, and the generic principles defined herein may be applied to other aspects.

Operations described in the present disclosure may be controlled and/or facilitated by software, hardware, or a combination of software and hardware. Operations described in the present disclosure may be controlled and/or facilitated by software executing on various machines. Such operations may also be controlled and/or facilitated specifically-configured hardware, such as field-programmable gate array (FPGA) specifically configured to execute the various steps of particular method(s). For example, relevant operations can be implemented in digital electronic circuitry, or in computer hardware, firmware, software, or in a combination thereof. In one example, a device may include a processor or processors. The processor may be coupled to a computer-readable medium, such as a random access memory (RAM). The processor may execute computer-executable program instructions stored in memory, such as executing one or more computer programs. Such processors may comprise a microprocessor, a digital signal processor (DSP), an application-specific integrated circuit (ASIC), field programmable gate arrays (FPGAs), and/or state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example computer-readable storage media, that may store instructions that, when executed by the processor, can cause the processor to perform the steps described herein as carried out, or assisted, by a processor. Examples of computer-readable media may include, but are not limited to, an electronic, optical, magnetic, or other storage device capable of providing a processor, such as the processor in a web server, with computer-readable instructions. Other examples of media comprise, but are not limited to, a floppy disk, CD-ROM, magnetic disk, memory chip, ROM, RAM, ASIC, configured processor, optical media, magnetic tape or other magnetic media, and/or any other medium from which a computer processor can read. The processor, and the processing, described may be in one or more structures, and may be dispersed through one or more structures. The processor may comprise code for carrying out one or more of the methods (or parts of methods) described herein.

The foregoing description has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in one implementation,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

What is claimed is:

1. An apparatus, comprising:
a plurality of markers embedded on a road, the plurality of markers arranged in a line and configured to define a border of at least one lane in a plurality of lanes on the road; and
wherein the plurality of markers are configured to dynamically assign a driving designation to the at least one lane on the road.

2. The apparatus of claim 1, wherein the driving designation comprises at least one of (a) a direction of traffic in the at least one lane, (b) a vehicle occupancy criteria for the at least one lane, (c) a vehicle speed limit on the at least one lane, or (d) an operational status of at the least one lane.

3. The apparatus of claim 1, wherein the border defined by the plurality of markers separates (a) lanes of traffic in opposing directions or (b) lanes of traffic in the same direction, based on the dynamically assigned driving designation of the lanes of traffic.

4. The apparatus of claim 1, wherein each lane in the plurality of lanes includes a plurality of lane portions, wherein the plurality of markers are further configured to dynamically assign to a first lane portion a first driving designation and dynamically assign a second lane portion a second driving designation different than the first driving designation.

5. The apparatus of claim 1, wherein the driving designations are dynamically assigned by a remote server.

6. An apparatus comprising:
a processor configured to obtain virtual representation information for a plurality of virtual markers arranged in a line to define a virtual border of at least one virtual lane in a plurality of virtual lanes on a road, the processor further configured to dynamically assign a driving designation to the at least one virtual lane on the road; and
a data storage unit configured to communicate with the processor and to store the virtual representation information.

7. The apparatus of claim 6, the driving designation comprising at least one of (a) a direction of traffic in the at least one virtual lane, (b) a vehicle occupancy criteria for the at least one virtual lane, (c) a vehicle speed limit on the at least one virtual lane, or (d) an operational status of the at least one virtual lane.

8. The apparatus of claim 6, wherein the processor is further configured to navigate a vehicle on the road based on the virtual representation information.

9. The apparatus of claim 6, wherein the processor is further configured to graphically display the virtual representation information on a display unit configured to virtually superimpose the virtual markers on the road.

10. The apparatus of claim 6, wherein the border defined by the plurality of markers separates (a) lanes of traffic in opposing directions or (b) lanes of traffic in the same direction, based on the dynamically assigned driving designation of the lanes of traffic.

11. The apparatus of claim 6, wherein each lane in the plurality of lanes includes a plurality of lane portions, wherein the plurality of markers are further configured to dynamically assign to a first lane portion a first driving designation and dynamically assign a second lane portion a second driving designation different than the first driving designation

12. The apparatus of claim 6, wherein the data storage unit is housed within a vehicle.

13. The apparatus of claim 6, wherein the driving designations are dynamically assigned by a remote server.

14. The apparatus of claim 13, wherein the remote server is further configured to dynamically assign a driving designation to at least one virtual portion in a virtual lane prior to a projected arrival of a vehicle at the virtual portion.

15. The apparatus of claim 14, wherein the remote server dynamically assigns the driving designation of at least one virtual portion in a virtual lane based on at least one of a real time traffic condition of the road or a history of traffic conditions of the road.

16. The apparatus of claim 15, wherein the real time traffic conditions are based on information provided by at least one sensor housed within at least one vehicle in communication with the remote server.

17. A method comprising:
dynamically assigning a driving designation to at least one lane in a plurality of lanes on a road; and
altering a pattern represented by a plurality of markers embedded on the road based on the dynamically assigning, the plurality of markers arranged in a line to define a border of the at least one lane on the road.

18. The method of claim 17, wherein the driving designation comprising at least one of (a) a direction of traffic in the at least one lane, (b) a vehicle occupancy criteria for the at least one lane, (c) a vehicle speed limit on the at least one lane, or (d) an operational status of at the least one lane.

19. The method of claim 17, wherein the driving designations are at least in part determined by crowd sourcing.

20. The method of claim 17, wherein the crowd sourcing is performed via traffic information gathered from a sensor housed in a vehicle or a history of traffic conditions of the road.
